(19) United States
(12) Patent Application Publication
(10) Pub. No.: US 2017/0295389 A1
(43) Pub. Date: Oct. 12, 2017

(54) DELAY OF SOCIAL MEDIA DURING TIME-SHIFTED VIEWING OF MULTI-MEDIA PRESENTATIONS

(71) Applicant: ECHOSTAR TECHNOLOGIES L.L.C., Englewood, CO (US)

(72) Inventor: Kevin Crist, Littleton, CO (US)

(73) Assignee: ECHOSTAR TECHNOLOGIES L.L.C., Englewood, CO (US)

(21) Appl. No.: 15/395,304

(22) Filed: Dec. 30, 2016

Related U.S. Application Data
(60) Provisional application No. 62/273,671, filed on Dec. 31, 2015.

(51) Int. Cl. H04N 21/262; H04N 21/845; H04N 21/4788; H04N 21/458

(52) U.S. Cl. CPC H04N 21/2625; H04N 21/458; H04N 21/8456; H04N 21/4788

(57) ABSTRACT

A method that provides a delay of social media feeds during time-shifted viewing of multi-media presentations including the steps of receiving a media presentation, time-shifting the media presentation for a period of time, receiving a social media message regarding the media presentation, and delaying presentation of the social media message for the period of time.

### TECHNICAL FIELD

The present disclosure generally relates to multi-media presentation technologies. More particularly, the present disclosure relates to systems and methods that provide a delay of social media feeds during time-shifted viewing of multi-media presentations.

### BACKGROUND

Most television viewers now receive their television signals through a content aggregator such as a cable or satellite television provider. Subscribers to a direct broadcast satellite (DBS) service, for example, receive television programming via a broadcast that is sent via a satellite to an antenna that is generally located on the exterior of a home or other structure. Other viewers receive television programming through conventional “over the air” television broadcasts, or through cable, wireless or other media. Programming is typically received at a receiver such as a set top box (STB) or the like that demodulates the received signals and converts the demodulated content into a format that can be presented to the viewer on a television or other display.

The proliferation of subscription television programming, the increasing number of available channels, and the corresponding increase in television programming have led to continued development of various user interactive features. Exemplary features may include the ability to set timers to record programs, the ability to set user preferences, for example, for how information is displayed, and the ability to lock or otherwise control access to channels. In particular, systems and methods have been developed that allow a user to control the display of a program through functions such as pause, play, rewind, fast forward, replay, slow, etc. Such systems and methods may generally be referred to as “time-shifting” systems and methods.

More recently, social media and networking has become much more prevalent among users of the Internet and similar communications networks. Many social media services have formed on the Internet and elsewhere. These communities typically allow members to conveniently share messages, pictures, audio files and/or other types information with each other, and often to directly inter-communicate via a chat, voice or other interface. Often, these shared messages, pictures, etc. relate to real time events being broadcast on a multi-media presentation. In the event a viewer of the multi-media presentation has time-shifted such presentation, the viewer may receive messages through social media regarding the presentation prior the viewers actual viewing of the presentation, thus making for a less that desirable viewing experience.

Accordingly, there remains a need in the art for systems and methods that provide a delay of social media feeds during time-shifted viewing of multi-media presentations. Furthermore, other desirable features and characteristics of the disclosure will become apparent from the subsequent detailed description and the appended claims, taken in conjunction with the accompanying drawings and this background of the disclosure.

### BRIEF SUMMARY

The present disclosure relates to systems and methods that provide a delay of social media feeds during time-shifted viewing of multi-media presentations. In one exemplary embodiment, a method is disclosed that provides a delay of social media feeds during time-shifted viewing of multi-media presentations including the steps of receiving a media presentation, time-shifting the media presentation for a period of time, receiving a social media message regarding the media presentation, and delaying presentation of the social media message for the period of time.

In another exemplary embodiment, a system that provides a delay of social media feeds during time-shifted viewing of multi-media presentations includes a media presentation system that provides a media presentation, a time-shifting device that time-shifts the media presentation for a period of time, a social media network that provides or relays a social media message regarding the media presentation, and a means for delaying presentation of the social media message for the period of time.

This summary is provided to describe select concepts in a simplified form that are further described in the Detailed Description. This summary is not intended to identify key or essential features of the claimed subject matter, nor is it intended to be used as an aid in determining the scope of the claimed subject matter.

### BRIEF DESCRIPTION OF THE DRAWINGS

The present disclosure will hereinafter be described in conjunction with the following drawing figures, wherein like numerals denote like elements, and wherein:

FIG. 1 is a system diagram of an exemplary multi-media system that is capable of delivering multi-media programming to a viewer;

FIG. 2 illustrates an embodiment of a DVR of FIG. 1;

FIG. 3 is a diagram of an exemplary architecture for a social network environment; and

FIG. 4 is a flowchart illustrating a method in accordance with some embodiments of the present disclosure.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

When using a DVR during popular live events (such as sports events) social media notifications can “spoil” the outcome of the event. By delaying social media notifications by the amount of delay of the event, these spoilers can be suppressed. An app that resides either in the cloud, or on selected devices (including hand held devices and on the DVR itself) that will filter and/or suppress social media notifications from providers such as FaceBook® and Twitter® for an amount of time equal to the delay of a DVR off of live programming. The app would allow a user to select specific events and event types, that when that event is delayed on a DVR, notifications would automatically (or also by opting in) be delayed. An enhancement to the app could be to filter on specific topics or users for this delay. For example, notifications from a specified group of “Friends” would remain live, but notifications from “Sports Providers” would be delayed. Moreover, such systems and methods would include the ability to apply filtering (dynamically) based the active pause buffer of a set top box, in order to adjust for the proper level of filtering in real time. Still further, such systems and methods would allow for the selection of a program by metadata (and user preferences), so if a user is watching ESPN® delayed by 15 minutes and a baseball game starts, and they have set a preference to suppress Tweets for “baseball” the filter would automatically kick in, without any program selection or intervention by the user (the selected filter plus metadata would create the decision point). As such, the set top box is provided with general criteria, and then using the metadata in the STB it dynamically makes the filtering determination without direct, or time specific, input from the user.

### Multi-Media System

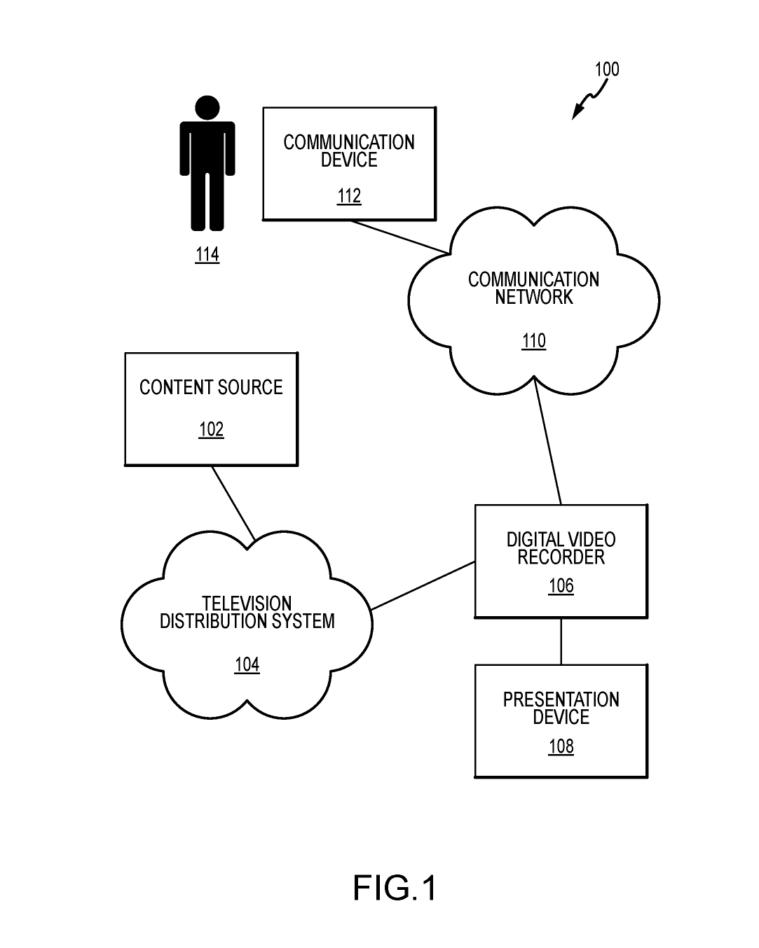

FIG. 1 is a system diagram of an exemplary multi-media system 100 that is capable of delivering multi-media programming to a viewer. In some embodiments, as shown in FIG. 1, the communication network includes a content source 102, a television distribution system 104, a DVR 106, a presentation device 108, a communication network 110 and a communication device 112. Each of these components will be discussed in greater detail below. The multi-media system 100 may include other components, elements or devices not illustrated for the sake of brevity.

The content source 102 is operable for receiving, generating and communicating content to one or more DVRs 106. The content to be received, processed, outputted and/or communicated may come in any of various forms including, but not limited to, audio, video, data, information, or otherwise. In at least one embodiment, the content source 102 is operable for receiving various forms and types of content from other sources, aggregating the content and transmitting the content to the DVR 106 through the television distribution system 104. It is to be appreciated that the content source 102 may receive practically any form and/or type of information from one or more sources including streaming television programming, recorded audio or video, electronic programming guide data and the like.

The television distribution system 104 is operable to transmit content from the content source 102 to the DVR 106. The television distribution system 104 may include any type of wired (e.g., cable and fiber) and/or wireless (e.g., cellular, satellite, microwave, and other types of radio frequency) communication medium and any desired network topology (or topologies when multiple mediums are utilized). Exemplary television distribution systems 104 include terrestrial, cable, satellite and internet protocol television (IPTV) distribution systems. In at least one embodiment, the television distribution system 104 broadcasts or multicasts content to a plurality of television receivers, e.g., DVR 106. The television distribution system 104 may also distribute content to a specific addressable television receiver, e.g., DVR 106, such as video-on-demand and the like. In at least one embodiment, the content source 102 may be embodied as a transmission facility of the television distribution system 104. Exemplary content sources 102 include over-the-air transmission facilities, cable television distribution head-ends, satellite television uplink centers, broadband or internet servers and the like.

The DVR 106 is operable to receive content from the television distribution system 104 and store the received content for subsequent presentation to the user 114. The DVR 106 is further operable to output the received and/or stored content for presentation by the presentation device 108. In at least one embodiment, the presentation device 108 is a display device (e.g., a television) configured to display content to a user. The DVR 106 may receive an audio/video stream in any format (e.g., analog or digital format), and store and output the audio/video stream for presentation by the presentation device 108. In at least one embodiment, the DVR 106 may be integrated with a television receiver, such as a satellite, cable, over-the-air, broadband or other type of television receiver that receives and demodulates television signals that are outputted for display on a display device (e.g., a television). As used herein, a television receiver or DVR may also be referred to as a set-top box, which is a television receiver that is located externally with respect to a display device. The DVR 106 may be further configured to output menus and other information that allow a user to control the output of audio/video content by the DVR 106, viewing electronic programming guides (EPGs), set recording timers and the like. In some embodiments, the DVR 106 and the presentation device 108 may be integrated as a device combining the functionality of a display device and television receiver/DVR or the like.

Responsive to particular recording timers, the DVR 106 coordinates the reception of video signals associated with a television program through a television receiving resource (e.g., a television tuner) and storage of the video signal onto a storage medium (e.g., a hard drive). The DVR 106 may include any number of television receiving resources utilized for receiving television programs. A DVR 106 minimally includes at least one television receiving resource to receive and record video signals associated with a television program. The DVR 106 may include multiple television receiving resources to record multiple television programs simultaneously. In at least one embodiment, the DVR 106 may include multiple types of television receiving resources, such as an over-the-air (ATA) tuner and a satellite and/or cable television tuner. In some embodiments, the DVR 106 may be operable to assign a recording timer associated with a particular program to a specified television receiving resource. For example, a first television program, broadcast between 7:00 P.M. and 8:00 P.M., may be assigned to a first satellite television tuner of the DVR 106, and a second television program, broadcast between 7:00 P.M. and 9:00 P.M., may be assigned to a second satellite television tuner of the DVR 106.

Priorities may also be assigned to particular recording timers to provide the DVR 106 with information for resolving recording conflicts. Thus, if a recording conflict occurs between two or more recording timers, then the DVR 106 may apply rules to the priority information to determine which program to record absent input by the user 114 requesting to resolve the conflict. For example, the earliest set recording timer may have the highest priority for recording. Similarly, a more recently set recording timer may have the highest priority for recording. In some embodiments, a user 114 may provide a recording priority for a particular timer when selecting the timer for recording. Thus, the particular rules applied by the DVR 106 for resolving recording conflicts may be determined based on desired design criteria.

The DVR 106 is further operable to exchange information with the communication device 112 through the communication network 110. The communication network 110 may include any type of network that provides any type of connectivity between the DVR 106 and the communication device 110. The communication network 110 may utilize any desired combination of wired (e.g., cable and fiber) and/or wireless (e.g., cellular, wireless, satellite, microwave, and radio frequency) communication mediums and any desired network topology (or topologies when multiple mediums are utilized). Exemplary communication networks include television distribution networks (e.g., satellite and cable television networks), wireless communication networks, public switched telephone networks (PSTN), the internet and local area networks (LAN) or wide area networks (WAN) providing data communication services.

The communication device 112 may include any type of device capable of connecting with the communication network 110 to receive information from the DVR 106. Exemplary communication devices 112 include telephones, mobile telephones, computers, personal digital assistants (PDAs), pagers and the like. The DVR 106 and the communication device 112 may communicate over any type of communication service or protocol. For example, the DVR 106 and the communication device 112 may exchange text data or the like via SMS or e-mail messages. In at least one embodiment, the communication device 112 and the DVR 106 may exchange information over a phone call, such as voice data or dual-tone-multi-frequency (DTMF) signals. In some embodiments, the DVR 106 and the communication device 112 may exchange information over any combination of the aforementioned communication services.

The DVR 106 is operable to identify recording conflicts between two or more recording timers associated with two or more television programs. Responsive to identifying a recording conflict, the DVR 106 is operable to initiate a communication with the communication device 112. The DVR 106 transmits information regarding the recording conflict to the communication device 112, e.g., the television programs or recording timers involved in the conflict, options for resolving the recording conflict and the like. In at least one embodiment, the explanation identifies the default resolution of the recording timer to be utilized by the DVR 106 absent any user input. The user 114 receives the notification regarding the recording conflict via the communication device 112 and determines an appropriate solution for resolving the recording conflict. For example, the user 114 may cancel one of the recording timers, adjust the time or duration of one or more of the recording timers or associate one of the timers with a different broadcast of the same program. The user 114 provides input to the communication device 112 requesting to resolve the recording conflict, and the communication device 112 transmits the input to the DVR 106 for further processing. The DVR 106 processes the input and modifies one or more of the conflicted recording timers in accordance with the user's 114 instructions. Responsive to the modified recording timers, the DVR 106 operates to record the selected television programs for subsequent viewing by the user 114.

### Time-Shifting Device

As noted above, the multi-media presentation system of FIG. 1 may include a time-shifting device, such as a digital video recorder (DVR). An exemplary DVR is described herein for purposes of illustration of an exemplary embodiment. However, it should be appreciated that other embodiments may utilize other time-shifting devices, such as those that may be resident on a portable electronic device such as a computer, laptop computer, tablet computer, smartphone, and the like.

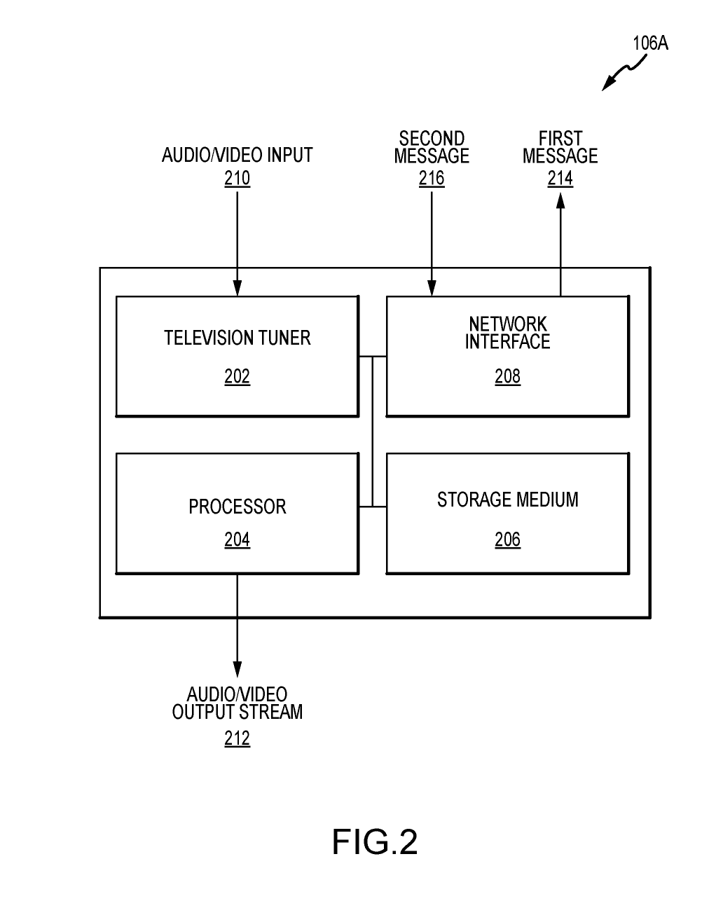

FIG. 2 illustrates an embodiment of a DVR of FIG. 1. FIG. 2 will be discussed in reference to the multi-media system 100 illustrated in FIG. 1. The DVR 106A includes a television tuner 202, a processor 204, a storage medium 206 and a network interface 208. Each of these components will be discussed in greater detail below. The DVR 106A may include other elements, components or devices which are not illustrated for the sake of brevity.

The television tuner 202 is operable to receive an audio/video input 210 from the content source 102 (see FIG. 1). More particularly, the television tuner 202 receives and tunes a television signal including television programming The television tuner 202 may receive an over-the-air broadcast, a direct broadcast satellite signal, a cable television signal or an internet protocol television (IPTV) signal and tune the audio/video input 210 to extract the selected television programming. In at least one embodiment, the DVR 106A may include multiple tuners 202 utilized to view and/or record multiple television programs simultaneously.

The storage medium 206 is operable to persistently store video signals recorded by the DVR 106A. The storage medium 206 may include any type of non-volatile memory appropriate for storing video signals recorded by the DVR 106A. Exemplary storage mediums 206 include hard drives (e.g., magnetic memory), flash memory, battery packed up memory and the like. In at least one embodiment, the storage medium 206 may be internally located within the DVR 106A. In other embodiments, the storage medium 206 may be located external with respect to the DVR 106A. The DVR 106A may also utilize a combination of internal and external storage mediums 206 for storage of video signals.

The processor 204 is operable to control the operation of the DVR 106A. The processor 204 may be a single processing device or a plurality of processing devices that cooperatively operate to control the operation of the DVR 106A. The processor 204 may include various components or modules for processing and outputting audio/video content. Exemplary components or modules for processing audio/video content include a demodulator, a decoder, a decompressor, a conditional access module and a transcoder module.

The processor 204 coordinates storage of the audio/video input 210 onto the storage medium 206. The processor 204 may also be operable to generate an audio/video output stream 212 based on the audio/video input 210, e.g., pass through the signal for display by an associated presentation device 108. The processor 204 is also operable to retrieve stored video content to generate an audio/video output stream 212 for display by the presentation device 108. An audio/video output stream 212 is outputted to the presentation device 108 (see FIG. 1) for presentation to the user 114. The processor 204 may incorporate circuitry to output the audio/video output streams 212 in any format recognizable by the presentation device 108 using any type of interface, such as composite video, component video, Digital Visual Interface (DVI) and High-Definition Multimedia Interface (HDMI), internet, 1394 and WiFi. The processor 204 may also incorporate circuitry to support multiple types of these or other audio/video formats. In at least one embodiment, as described above, the DVR 106A may be integrated with the presentation device 108, and the processor 204 may be operable to control the presentation of the audio/video output stream 212.

To coordinate the storage of the audio/video input 210, the processor 204 is operable to receive user input requesting to record one or more television programs. The processor 204 responsively sets recording timers associated with the television programs. The processor 204 is further operable to output user interface menus and other information to allow the user 114 to view the recording timers, modify recording timers, identify recording conflicts and provide input for resolving the recording conflicts in a desired manner.

The network interface 208 is operable to communicate with the communication device 112 through the communication network 110. More particularly, the network interface 208 exchanges data with the communication device 112 regarding a recording conflict. The network interface 208 may communicatively couple to the communication network 110 using any type of wired or wireless communication link and using any type of network topology and protocol. For example, the network interface 208 may include an Ethernet port that communicatively couples to the base station over the internet. In at least one embodiment, the network interface 208 may be assigned a communication identifier for communicating with the communication network 110 and other devices, such as the communication device 112. For example, the network interface 208 may be assigned an e-mail address, phone number or the like for sending and receiving communications.

### Social Media Network

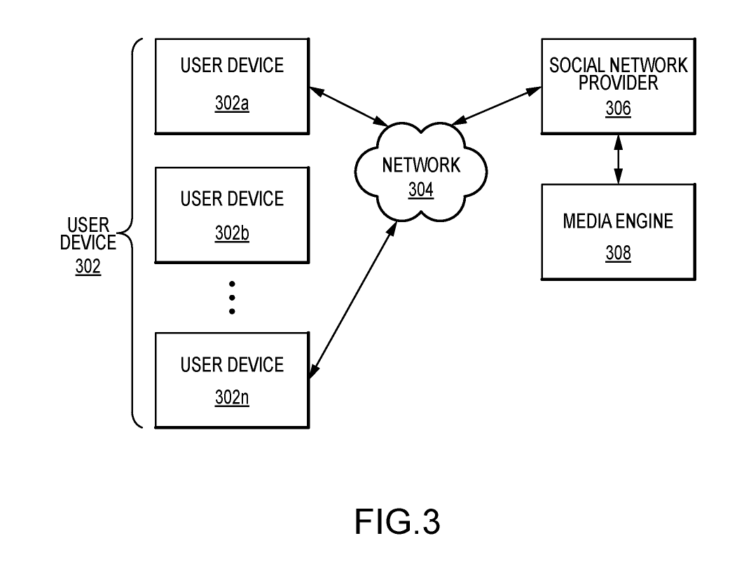

As noted above, the user 114 may receive messages, communications, and the like through a social media network while watching a time-shifted multi-media program. For purposes of illustrating an exemplary embodiment, a brief description of an exemplary social media network that may provide such messages and communications is set forth below. In one embodiment, FIG. 3 is a diagram of an exemplary architecture for a social network environment. User devices 302, such as a user device 302a, a user device 302b, and a user device 302n, communicate over a network 304 with a social network provider 306. The user devices 302a-302n may include any device associated with one or more users, such as a cellular telephone, a personal digital assistant, a desktop or a laptop computer, and so forth. Any types of user devices 302 are within the scope of various embodiments.

The social network provider 306 may include any user or entity that provides social networking services, communication services, dating services, and so forth. For example, the social network provider 306 may host a website that allows one or more users at the user devices 302 to communicate with one another via the website. In one instance, the user associated with the user device 302a may communicate with the user associated with the user device 302b via a social networking website associated with the social network provider 306 that offers the user an opportunity to connect or reconnect with one or more other users that attended, for example, the same university as the user.

A media engine 308 is coupled to the social network provider 306. In one embodiment, the media engine 308 can select items of media content based on the user's relationships with other users through the social network provider 306. The media engine 308 analyzes the frequency of the user's interactions with other users through the social network provider 306 and with the selected items of media. The results of this analysis are used to rank the importance of the other users to the user, so that new items of media content are selected and displayed to the user in the order of the content's anticipated importance or interest to the user.

For example, a user at the user device 302 a uses a cursor to click on items of media content related to his sister Abby very frequently, and to click on emails from his friend Bob somewhat less frequently. The items of media content selected by the media engine 308 will be dynamically presented to the user at the user device 302a with an importance ranking based on an analysis of the frequencies of the user's interactions with items of media content associated with his friends, so that items of media content associated with Abby will be presented first to the user at the user device 302a, followed by items of media content associated with Bob. For example, the items of media content may be news stories about the other users Abby and Bob. Such news stories would be presented to the user as stories about “your sister” and “your best friend,” so that the wording and content of the stories would not be meaningful to someone other than the users.

In an embodiment not shown, the media engine 308 can receive media content preference settings selections from the users at the user devices 302. The media engine 308 can save the media content preference settings to a profile associated with each user. Once the media content preference settings are selected by the user, the media engine 308 can use the media content preference settings to insure that items of media content concerning particular relationships between the user and other users are not displayed to the user.

The users at the user devices 302 can group other users, events or objects according to categories, such as “friends”, “school”, “geography”, “business”, and so forth, and select a media content preference setting applicable to an entire category; any type of grouping may be employed by the user and/or the social network provider 306. Further, according to some embodiments, the user may make media content preference settings applicable to individual other users, events or objects. For instance, the user may select media content preference settings for Jane, media content preference settings for John, and/or media content preference settings for groups of users, which may or may not include Jane and John.

### System and Method For Delaying Social Media Feed

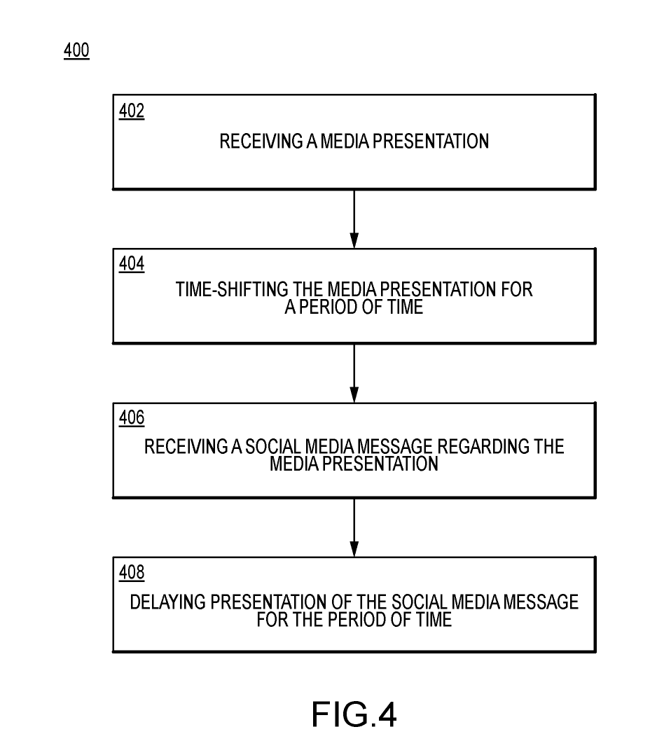

As noted above, when using a DVR during popular live events (such as sports events) social media notifications can “spoil” the outcome of the event. By delaying social media notifications by the amount of delay of the event, these spoilers can be suppressed. Accordingly, an exemplary method 400 that provides a delay of social media feeds during time-shifted viewing of multi-media presentations is shown in FIG. 4. Step 402 includes receiving a media presentation. This step 402 may be accomplished using the system as shown above in FIG. 1. Step 404 includes time-shifting the media presentation for a period of time. This step 404 may be accomplished using the system as shown above in FIG. 2. Step 406 includes receiving a social media message regarding the media presentation. This step 406 may be accomplished using the system shown above in FIG. 3. It should be noted that the systems of FIGS. 1, 2, and 3 may all be connected together, and may be able to communicate with one another, via a common network, such as the Internet. Further, step 408 includes delaying presentation of the social media message for the period of time. Various manners in which to accomplish step 408 are set forth in greater detail below.

In some embodiments, delaying the presentation of the social media message may be accomplished by a computer application (“app”) that is resident on a non-transitory storage medium. For example, the app could reside in the “cloud” (as used herein, the term “cloud” storage refers to the kind of Internet-based computing, where shared resources, data and information are provided to computers and other devices on-demand; cloud computing and storage solutions provide users and enterprises with various capabilities to store and process their data in third-party data centers). In another example, the app could reside on the DVR device or other time-shifting device. In yet another example, the app could reside on the device wherein the social media message is received, such as the user's portable electronic device such as a computer, laptop computer, tablet computer, smartphone, and the like. Regardless of the particular location of the non-transitory storage medium wherein the app is stored, the app is configured to filter and/or suppress social media messages from social media networks such as FaceBook® and Twitter® for an amount of time (the above-noted period of time) equal to the delay of a DVR off of live programming The app detects that the user has initiated time-shifting of a multi-media program and, based on this detecting, causes presentation of social media messages to be delayed for an equal amount of time to the user. As noted above, the multi-media presentation system, the time-shifting system, and the social networking system (including the device on which such messages are received) may all be commonly and communicatively connected by network, such as the internet, to allow for electronic communications to enable the above-described functions of detecting and delaying, etc.

In some embodiments, the app is configured to allow a user to select specific events and event types, which when such event is delayed on a DVR or other time shifting-device, social media messages notifications would automatically (or also by opting in) be delayed. Event types may include sporting events, news events, movies, political events, and the like. Selection may be made by the user among various sub-categories of these events as well, for example sports may be sub-categorized into football, baseball, basketball, etc. Thus, the user is able to time-shift some programs without social media messages relating thereto being delayed, wherein other time-shifted programs will result in social media messages being delayed. For example, the user could select to have delayed messages for time-shifted sports events, but not movies, and so on.

In some embodiments, the app is configured to filter on specific topics or users for delaying social media messages. For example, notifications from a specified group of “Friends” would remain live, but notifications from “Sports Providers” would be delayed. Other possible groups could include co-workers, political pundits, celebrities, and the like. Thus, messages for some groups will not be delayed during a time-shifted viewing event, while messages from other groups will be delayed. In the context of topics, one can image various current events and the like that become topics of conversation on social media, and such topics may be selectively filtered for delay/no delay by the user.

In some embodiments, the app may be configured to include the ability to apply filtering (dynamically) based the active pause buffer of a set top box (i.e., a social media message delay feature integrated into a STB of the multi-media system), in order to adjust for the proper level of filtering in real time. Still further, such systems and methods would allow for the selection of a program by metadata (and user preferences), so if a user is watching ESPN® delayed by 15 minutes and a baseball game starts, and they have set a preference to suppress Tweets for “baseball” the filter would automatically kick in, without any program selection or intervention by the user (the selected filter plus metadata would create the decision point). As such, the set top box is provided with general criteria, and then using the metadata in the STB it dynamically makes the filtering determination without direct, or time specific, input from the user. In this manner, it should be appreciated that the app will have access to the metadata of an electronic programming guide of the multi-media presentation system, for example.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method that provides a delay of social media feeds during time-shifted viewing of multi-media presentations comprising the steps of:
receiving a media presentation;
time-shifting the media presentation for a period of time;
receiving a social media message regarding the media presentation; and
delaying presentation of the social media message for the period of time.

2. A system that provides a delay of social media feeds during time-shifted viewing of multi-media presentations comprising:
a media presentation system that provides a media presentation;
a time-shifting device that time-shifts the media presentation for a period of time;
a social media network that provides or relays a social media message regarding the media presentation; and
a means for delaying presentation of the social media message for the period of time.
